(19) United States
(12) Patent Application Publication
(10) Pub. No.: US 2005/0108013 A1
(43) Pub. Date: May 19, 2005

(54) Phonetic coverage interactive tool

(75) Inventor: Samuel L. Karns, Delray Beach, FL (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/712,445

(22) Filed: Nov. 13, 2003

(51) Int. Cl. G10L 15/00

(52) U.S. Cl. 704/254

(57) ABSTRACT

A phonetic coverage interactive tool is provided to improving the phonetic coverage of a user adaptation script to be used with speech recognition systems. The tool reads a given script for a given language. The tool analyzes the script to produce a set of statistics indicating the coverage of phonemes in the particular language by the phonemes contained in the words in the script. An interactive mode allows users to add or remove words to the script to modify the phoneme coverage as quantified in the statistics. A user can also query the tool to produce a set of words have a desired set of phonemes, which can then be added to the script to produce a more uniform phoneme coverage for the script.

### BACKGROUND OF THE INVENTION

1. Statement of the Technical Field

The present invention relates to the field of computer speech recognition and more particularly to a method and system for developing a script to be used with a speech recognition application such that the script can be used to more uniformly adapt the application to the particular speech attributes of an end user of the application.

2. Description of the Related Art

Speech recognition is the process by which an acoustic signal received by a microphone is converted to a set of words by a computer. These recognized words may then be used in a variety of computer software applications for purposes such as document preparation, data entry and command and control. Speech recognition is generally a difficult problem due to the wide variety of pronunciations, individual accents and speech characteristics of individual speakers. Consequently, language models are often used to help reduce the search space of possible words and to resolve ambiguities as between similar sounding words. Such language models tend to be statistically based systems and can be provided in a variety of forms.

Many speech recognition systems require adaptation of the speech recognition application to the voice of a particular user. Furthermore, since each particular user will tend to have their own style of speaking, it is important that the attributes of such speaking style be adapted to the language model. In speech recognition systems that support speaker adaptation, sample texts, or scripts, are commonly provided that are read aloud by the end user as an example of a particular users' voice signature and speaking style. This information may thereafter be used, if suitable, to update the language model and to adapt the speech recognition functionality of the application.

It is critical that these scripts provide even and comprehensive coverage of the set of phonemes for a given language. A phoneme is basic sound unit of any spoken language. Phonemes can also be viewed as theoretical constructs with a basis in the psychology of language. Phonemes are pronounced as allophones, which are the concrete sounds that correspond to the phoneme. Phonemes are generally denoted between slashes, while sounds are between square brackets. As an example, /t/ is a phoneme and may be realized as [t] (as in the t in stop), or [th] (as the t in tin), among others. The former sound is not aspirated while the latter is. All of the phonemes in a given language should be covered by the speaker adaptation script. Otherwise, the speech recognition application will be ill suited to recognize all of the possible sounds in a given language.

Developing a proper script for any given language, which has a given set of phonemes, is no mean feat. It would be desirable to provide a method and system which allows a developer of a script to immediately ascertain the phoneme coverage of the script, including the extent to which individual phonemes are covered, as well as the existence of any missing phonemes. It would also be desirable to provide an interactively method and system which would allow the script developer to patch a given script by filling in any gaps in phoneme coverage by adding and/or removing words having a certain set of phonemes. There are no known solutions for this problem other than manual cross-referencing.

### SUMMARY OF THE INVENTION

The present invention addresses the deficiencies of the art in respect to development of adequate scripts to be used for adapting speakers to speech recognition systems, and provides a novel and non-obvious method, system and apparatus for such a phonetic coverage interactive tool.

Methods consistent with the present invention include developing a script to be used with speech recognition systems. A language phoneme data can be retrieved for a given language. In this regard, the language phoneme data can include the plurality of phonemes which occur in the given language. A script data further can be retrieved, which can include a script having a set of one or more phonemes. Each phoneme in the script data can be counted to produce a count data for each of the phonemes in the language phoneme data. Consequently, a set of statistical data derived from the count data can be generated. Specifically, the set of statistical data can include one or more metrics of the extent to which the phonemes in the language phoneme data are included in the script data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a computer system for speech recognition with which the method and system of the invention can be used;

FIG. 2 is a block diagram showing the arrangement of the inputs and outputs of the speech recognition script development tool of the present invention;

FIG. 3A is a flow chart illustrating a process for analyzing a script and producing a set of statistics for the script;

FIG. 3B is a flow chart illustrating a process for interactively developing a script using the development tool of the present invention.

### DETAILED DESCRIPTION OF THE PREFERRED EMBODIMENTS

The present invention is a phonetic coverage interactive tool for developing a script to be used with speech recognition systems.

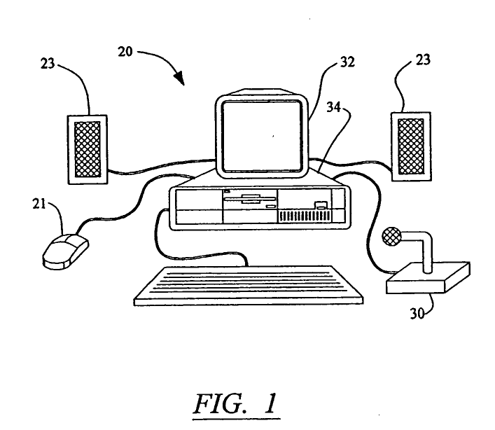

FIG. 1 shows a typical computer system 20 for use in conjunction with the present invention. The system is preferably comprised of a computer 34 including a central processing unit (CPU), one or more memory devices and associated circuitry. The system also includes a microphone 30 operatively connected to the computer system through suitable interface circuitry or a “sound board” (not shown), and at least one user interface display unit 32 such as a video data terminal (VDT) operatively connected thereto. The CPU can be comprised of any suitable microprocessor or other electronic processing unit, as is well known to those skilled in the art. An example of such a CPU would include the Pentium brand microprocessor available from Intel Corporation or any similar microprocessor. Speakers 23, as well as an interface device, such as mouse 21, can also be provided with the system, but are not necessary for operation of the invention as described herein.

The various hardware requirements for the computer system as described herein can generally be satisfied by any one of many commercially available high speed multimedia personal computers offered by manufacturers such as International Business Machines Corporation (IBM), Hewlett Packard, or Apple Computers. In addition to personal computers, the present invention can be used on any computing system which includes information processing and data storage components, including a variety of devices, such as handheld PDAs, mobile phones, networked computing systems, etc. Indeed, the present invention provides a development tool for the scripts to be used with speech recognition applications, so that the present invention can be used in conjunction with any system where a speech recognition application can be used.

A speech recognition application typically requires that a user's voice be adapted to the system onto which the application is attached. In the case of the system of FIG. 1, a user will typically read a given script into the microphone 30, whereby the user's voice will be recorded and analyzed by the speech recognition engine application and speech text processor applications that may be stored in the computer 34. This script should, as stated in the background section hereinabove, cover the widest possible array of sounds in the particular language used. A tool is therefore necessary to develop such a script, for use in such systems.

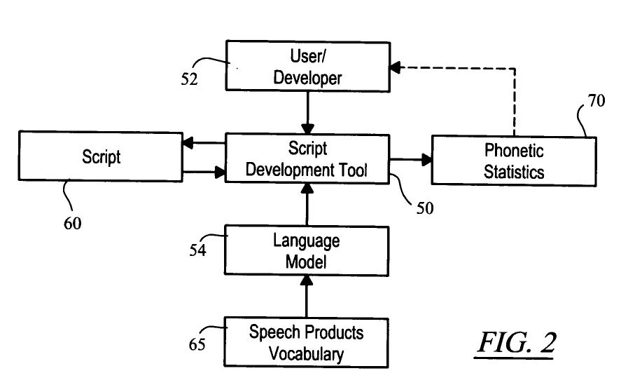

FIG. 2 is a block diagram showing the arrangement of the inputs and outputs of the speech recognition script development tool of the present invention. A script development tool 50 is a software or computing application which is operated by a user or developer 52. The tool 50 incorporates a language model 54 for the particular language to be used with the speech recognition application for which the user adaptation script 60 is to be used. Included in the language model 54 is a particular speech products vocabulary 65 which defines the set of speech products, or words, that the language model uses, and that the tool 50 will recognize.

The tool 50 receives a starting script 60 as an input and analyzes the words and phonemes in the script, given the particular language model 54 and the speech products vocabulary 65. It thereafter produces a set of statistical results 70 as an output, which mainly include statistics as to the particular phonetics of the starting script 60. These “phonetic statistics” may include data as to the number of times each phoneme, as defined by the language model, occurs in the script 60, or data as to which phonemes do not appear at all in the script 60. The user 52 will then inspect the results 70, on any device which is capable of reproducing the results in a perceptible form, and decide whether any changes need to be made in the script 60.

If the script 60 is lacking in certain phonemes, the user 52 may then enter a word containing the missing phonemes into the script development tool 50, which updates the script 60, and reanalyzes the script 60 to produce a new set of statistics 70. These statistics can thereafter be reanalyzed for phoneme coverage, and so forth. In addition to adding words to the script 60, the user may also remove words, if the phoneme coverage is not as uniform as desired.

The tool 50 is also equipped to search the speech products vocabulary 65 for certain words having the desired set of phonemes which the user may wish to add to the script 60. The speech products vocabulary 65 can also restrict the analysis of the script 60 by tool 50, in that only words that are included in the vocabulary 65 are read by the tool 50 and included in the statistical results 70.

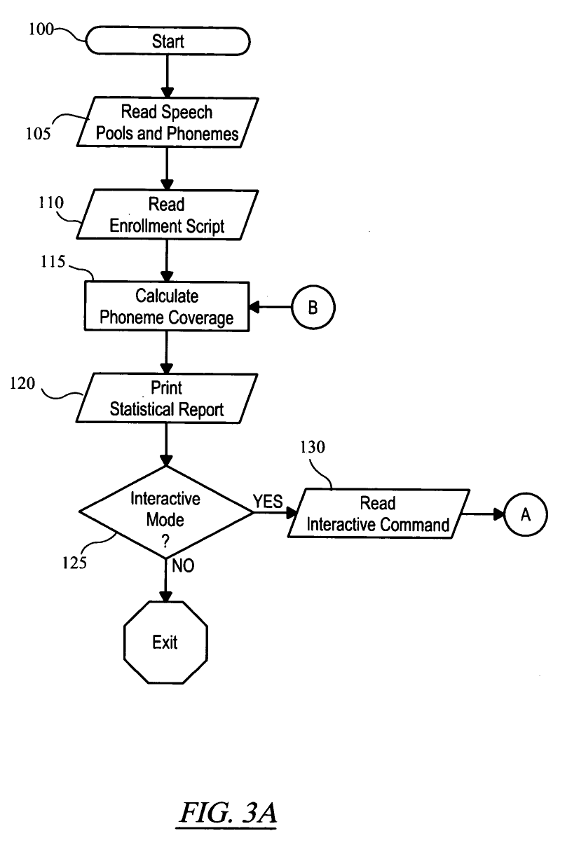

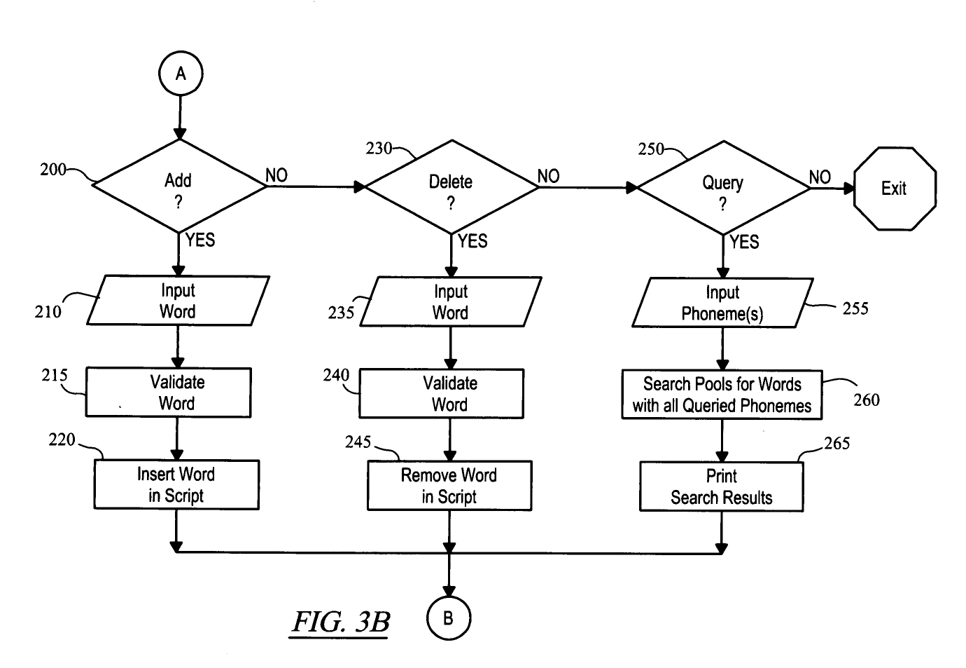

FIG. 3A is a flow chart illustrating a process for analyzing a script and producing a set of statistics for the script. As shown in FIG. 3A, after initializing the tool at step 100, the process continues in step 105, where the particular speech products vocabulary, or speech pool, is read for the particular language chosen by the user. In addition to the speech pool, the set of all phonemes for the language is read by the tool. Then the process reads the script at step 110. This is the “enrollment” script which is to be developed by the tool. The process thereafter calculates the phoneme coverage of the script in step 115. This can be accomplished by reading each word in the script, reading the phonemes contained in the word, and updating the count data for each phoneme. These count data are tallied for each phoneme in the master “phoneme data” for the particular language as read by the tool in step 105. If a particular word in the script is not included in the speech pool, the tool will also flag the word as unread, and store the result for reporting.

Once all the phonemes in all the words are read by the tool in step 115, the process proceeds to step 120, where the tool prepares and prints the statistical data in the form of a report listing a certain number of statistics on the phoneme coverage of the script. These statistics may include: (i) a list of all the phonemes in the language, with a count of the number of times each phoneme occurred in the script, (ii) a list of any words not included in the speech pool, (iii) a ratio of the phonemes in the script as a percentage of the total number of phonemes for the script, (iv) a listing of phonemes that are completely absent from the script, and (v) various other statistics that can be readily derived from the above-listed data as is well known to those skilled in the art.

The process then prompts a user to enter the interactive mode in step 125. If no interactive mode is selected, the process ends. If however, the user desires to enter interactive mode and selects the mode, the process proceeds to step 130, where the user is prompted for an interactive mode command. The rest of the process executed in the interactive mode is set forth in FIG. 3B and flows from jump circle “A” in FIG. 3A.

FIG. 3B is a flow chart illustrating a process for interactively developing a script using the development tool of the present invention. The process flows from jump circle “A” as shown, which is the connection point from the jump circle “A” shown in the flowchart of FIG. 3A. In step 200, the process determines whether a user has chosen to add a word to the script in the interactive command prompt of step 130. An addition of a word may be necessary is the user feels that the statistics as reported in step 120 revealed a lack of a particular set of phonemes in the script. By adding words with the phonemes, the user can adjust the script so that the statistics produce a report showing a more uniform phoneme coverage for the script.

If the user so chooses to add a word in step 200, the process proceeds to step 210, where the word is input to the system and the tool reads the word. In step 215, the process determines whether the input word in included in the speech pool for the language, and thereby “validates” the word. If the word is not included, the word is not valid, and the tool returns a message to the user of such invalidity. If however, the word in valid, the process inserts the word in the script in step 220. The process then proceeds to jump circle “B” and reenters the flowchart shown in FIG. 3A from jump circle “B” therein, and returns to step 115, whereby the phoneme coverage for the script is recalculated with the newly added word.

If however, in step 130, the user chooses not to add a word, the process in step 200 determines that no word is to be added, and proceeds to step 230, where the process determines a command has be entered to delete a word from the script. If yes, the process receives the word input for the word to be deleted in step 235. In step 240, the process again validates the input word, this time verifying that word input is indeed included in the script. If not, the process returns an error message to the user. If the word is valid, the process removes the word from the script in step 245, and proceed through jump circles “B” to step 115 in FIG. 3A, to recalculate the phoneme statistics for the script without the removed word.

It is also possible that, in step 130, the user may see that a certain phoneme coverage is not desirable, and that certain phonemes are missing from the given script. The user may then wish to pick certain words having the missing phonemes, but, as is often the case, may not readily know which word or words contain such phonemes. The user can then enter a query command at step 130 in FIG. 3A, to query the tool for words containing the desired phonemes.

Returning now to FIG. 3B, if the process determines in step 200 that no word is to be added, and in step 230 that no word is to be deleted, it proceeds to step 250, where it determines if a phoneme query is desired. If no query is entered, the process first determines whether to terminate, and if so, exits. If however, a non-termination command, or some other non-recognized command is entered, the process returns to step 130 in FIG. 3A. If a query has been entered, the process proceeds to step 255, whereby one or more phonemes are input by the user into the tool. The tool thereafter searches the speech pool in step 260 for one or more words which collectively contain all of the desired phonemes. These words are then displayed or printed as a result in step 265.

The development tool of the present invention can therefore be used to take a given script and correct the phoneme coverage for the script, for any given language. It greatly reduces the amount of time required to develop such a script, and gives developers an instant picture of the phonetic statistics of any script, as it is developed.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method for developing a script to be used with speech recognition systems, said method comprising the steps of:
reading language phoneme data for a given language, the language phoneme data having a plurality of phonemes occurring in the given language;
reading script data having a set of one or more phonemes;
counting each phoneme in the script data to produce a count data for each of the plurality of phonemes in the language phoneme data;
generating a set of statistical data derived from the count data, the set of statistical data including one or more metrics of the extent to which the phonemes in the language phoneme data are included in the script data.

2. The method of claim 1, wherein the script data includes one or more words, each word having one or more of the set of one or more phonemes, and further comprising:
reading vocabulary data having one or more words;
comparing each word in the script data with the vocabulary data; and
returning an error message if a word in the script data is not included in the vocabulary data.

3. The method of claim 2, wherein the step of counting each phoneme in the script data to produce a count data for each of the plurality of phonemes in the language phoneme data includes the steps of:
comparing each word in the script data with the vocabulary data;
returning an error message if a word in the script data is not included in the vocabulary data; and
counting each phoneme in each word in the script data if a word in the script data is included in the vocabulary data.

4. The method of claim 1, wherein the set of statistical data includes:
an occurrence data for each of the phonemes in the phoneme data, each occurrence data indicating a number of occurrences of the phoneme in the script data.

5. The method of claim 1, wherein the set of statistical data includes:
a ratio data, each ratio data being the number of phonemes in the script data as a percentage of the number of the plurality of phonemes in the phoneme data.

6. The method of claim 1, wherein the set of statistical data includes:
a missing phoneme data, each missing phoneme data being a list of the phonemes in the language phoneme data not included in the script data.

7. The method of claim 1, wherein the script data includes one or more words, and further comprising the steps of:
reading a vocabulary data having one or more words;
reading an additional word having one or more phonemes;
comparing the additional word with the vocabulary data;
adding the additional word to the script data if the additional word is included in the vocabulary data.

8. The method of claim 1, wherein the script data includes one or more words, and further comprising the steps of:
reading a vocabulary data having one or more words;
reading an additional word having one or more phonemes;
comparing the additional word with the script data;
removing the additional word from the script data if the additional word is included in the script data.

9. The method of claim 1, wherein the script data includes one or more words, and further comprising the steps of:
reading a vocabulary data having one or more words;
reading a set of one or more desired phonemes;
searching the vocabulary data for one or more words having the set of one or more desired phonemes;
generating a report of one or more additional words having the set of one or more desired phonemes, if the one or more additional words having the set of one or more desired phonemes are included in the vocabulary data.

10. A machine readable storage having stored thereon a computer program for developing a script to be used with speech recognition systems, said computer program comprising a routine set of instructions for causing the machine to perform the steps of:
reading a language phoneme data for a given language, the language phoneme data having a plurality of phonemes occurring in the given language;
reading a script data having a set of one or more phonemes;
counting each phoneme in the script data to produce a count data for each of the plurality of phonemes in the language phoneme data;
generating a set of statistical data derived from the count data, the set of statistical data including one or more metrics of the extent to which the phonemes in the language phoneme data are included in the script data.

11. The machine readable storage of claim 10, wherein the script data includes one or more words, each word having one or more of the set of one or more phonemes, and for further causing said machine to perform the steps of:
reading a vocabulary data having one or more words;
comparing each word in the script data with the vocabulary data; and
returning an error message if a word in the script data is not included in the vocabulary data.

12. The machine readable storage of claim 11, wherein the step of counting each phoneme in the script data to produce a count data for each of the plurality of phonemes in the language phoneme data includes the steps of:
comparing each word in the script data with the vocabulary data;
returning an error message if a word in the script data is not included in the vocabulary data; and
counting each phoneme in each word in the script data if a word in the script data is included in the vocabulary data.

13. The machine readable storage of claim 10, wherein the set of statistical data includes:
an occurrence data for each of the phonemes in the phoneme data, each occurrence data indicating a number of occurrences of the phoneme in the script data.

14. The machine readable storage of claim 10, wherein the set of statistical data includes:
a ratio data, each ratio data being the number of phonemes in the script data as a percentage of the number of the plurality of phonemes in the phoneme data.

15. The machine readable storage of claim 10, wherein the set of statistical data includes:
a missing phoneme data, each missing phoneme data being a list of the phonemes in the language phoneme data not included in the script data.

16. The machine readable storage of claim 10, wherein the script data includes one or more words, and further causing the machine to perform the steps of:
reading a vocabulary data having one or more words;
reading an additional word having one or more phonemes;
comparing the additional word with the vocabulary data;
adding the additional word to the script data if the additional word is included in the vocabulary data.

17. The machine readable storage of claim 10, wherein the script data includes one or more words, and further causing the machine to perform the steps of:
reading a vocabulary data having one or more words;
reading an additional word having one or more phonemes;
comparing the additional word with the script data;
removing the additional word from the script data if the additional word is included in the script data.

18. The machine readable storage of claim 10, wherein the script data includes one or more words, and further causing the machine to perform the steps of:
reading a vocabulary data having one or more words;
reading a set of one or more desired phonemes;
searching the vocabulary data for one or more words having the set of one or more desired phonemes;
generating a report of one or more additional words having the set of one or more desired phonemes, if the one or more additional words having the set of one or more desired phonemes are included in the vocabulary data.

19. A script development tool configured for coupling to a script having a set of one or more phonemes and programmed to both count each phoneme in said script to produce count data for each phoneme in a selected language, and also to generate a set of statistical data derived from said count data, the set of statistical data comprising one or more metrics of the extent to which each phoneme in said selected language is included in said script.

20. The tool of claim 19, wherein the script includes one or more words, and wherein the tool is further programmed to read a vocabulary data having one or more words, and to read an additional word having one or more phonemes, and is also programmed to compare the additional word with the vocabulary data and add the additional word to the script data if the additional word is included in the vocabulary data, and is also programmed to compare the additional word with the script and remove the additional word from the script data if the additional word is included in the script data.
